(19) United States
(12) Patent Application Publication
(10) Pub. No.: US 2024/0189074 A1
(43) Pub. Date: Jun. 13, 2024

(54) APPARATUS, SYSTEM AND METHOD FOR DIRECT BONDING OF ORTHODONTIC BRACKETS

(71) Applicant: 2860296 Ontario lnc., Sault Ste Marie (CA)

(72) Inventor: Michael Shunock, Toronto (CA)

(21) Appl. No.: 18/534,528

(22) Filed: Dec. 8, 2023

Related U.S. Application Data
(60) Provisional application No. 63/431,168, filed on Dec. 8, 2022.

(51) Int. Cl. A61C 7/14

(52) U.S. Cl. CPC A61C 7/146

(57) ABSTRACT

A dental apparatus for use in direct bonding orthodontic applications to facilitate precise positioning of orthodontic brackets on the user's teeth includes a body portion comprising first, second and third sections, where the first section is uniquely configured with a plurality of guide sections, wherein each guide section generally comprises a first wall, a second wall and a medial wall and is uniquely shaped and sized to permit the ready and accurate positioning, and direct tooth bonding, of orthodontic brackets within each guide section. Associated systems and methods are also described.

### TECHNICAL FIELD

The present disclosure relates generally to the field of orthodontics and in particular to apparatuses, systems and methods for bonding orthodontic brackets.

### BACKGROUND

Direct and indirect adhesive bonding of orthodontic brackets (metal, ceramic, other) to tooth enamel are the two primary methods used by orthodontists today to attach these brackets to the teeth. Accurate bracket placement ensures that the prescription in the bracket will lead to the proper alignment of the tooth crown and root for both the top (maxillary) and bottom (mandibular) teeth, and allow for the proper fit between the top and bottom teeth (occlusion).

Indirect bonding in orthodontics generally involves the creation of custom trays to position brackets accurately on teeth, improving the precision of placement. This technique enhances overall treatment efficiency by reducing chair time and increasing predictability in tooth movement. Additionally, indirect bonding allows for better control over bracket placement angles, optimizing force application and minimizing the need for adjustments during subsequent visits. The indirect bonding method often leads to improved patient comfort and satisfaction.

While indirect bonding in orthodontics has its benefits, there are also some disadvantages to consider. One notable drawback is the initial time and cost involved in creating custom trays for each patient. The process of fabricating these trays can be time-consuming and requires specialized equipment. The most often used method involves the use of two trays to transfer the brackets to the teeth: an outer hard shell and an inner thermoplastic flexible inner tray. Additionally, any inaccuracies in the tray design or bracket positioning can result in compromised treatment outcomes, emphasizing the importance of precision during the setup phase.

Another potential challenge is the need for skilled professionals who are proficient in the indirect bonding technique. Training and expertise are crucial to ensure the trays are accurately fabricated and properly applied and seated in the patient's mouth. Changes in the patients soft tissues (gingiva) and the pressure applied by the clinician while seating the trays can comprise bracket placement and bond strength. Any errors in this process may necessitate additional chair time for adjustments, somewhat offsetting the anticipated time savings.

Furthermore, some orthodontists argue that the direct bonding technique allows for better chairside control and immediate feedback during bracket placement, which could be lost with the indirect approach. While indirect bonding offers advantages, the initial investment in time, cost, and the requirement for specialized skills are important considerations when evaluating its application in orthodontic practice.

The direct bonding technique in orthodontics involves the placement of orthodontic brackets directly onto the teeth without the use of custom trays. This technique has been a standard practice for many years and offers several advantages, making it the most widely used method in orthodontic treatment.

One of the primary advantages of direct bonding is the immediate chairside control that orthodontists have during the bracket placement process. This allows for real-time adjustments and ensures that brackets are precisely positioned on each tooth. Direct bonding provides clinicians with the flexibility to make on-the-spot modifications based on the patient's specific dental anatomy and treatment needs. Orthodontists can adapt to variations in tooth size, shape, and position, optimizing bracket placement for each individual patient.

Orthodontists can rely on visual and tactile feedback during direct bonding. This hands-on approach allows for a better assessment of the bracket placement, ensuring that brackets are securely bonded to the tooth surface.

Unlike indirect bonding, the direct bonding technique does not require the fabrication of custom trays for each patient. This minimizes laboratory costs and can result in a more cost-effective orthodontic treatment process. Without the need for custom trays, orthodontists can streamline the bracket placement process, potentially increasing the number of patients treated within a given timeframe.

In straightforward cases with minimal complexity, direct bonding may result in shorter overall treatment times. The ability to make immediate adjustments and proceed with treatment without waiting for custom trays can contribute to treatment efficiency.

While the direct bonding technique in orthodontics is widely used and has many advantages, there are also some disadvantages associated with this method. Achieving precise bracket placement can be very challenging with the direct bonding technique, especially in complex cases. Factors such as tooth morphology, malalignment, and variations in tooth size can make it more difficult to achieve the same level of precision as with indirect bonding. Also, the level of ability and amount of training of the clinician can also lead to a wide range of variability in bracket placement between.

In cases with intricate or challenging tooth positions, direct bonding may require more chair time. Orthodontists may need to spend additional time adjusting and repositioning brackets to achieve the desired alignment, potentially leading to longer appointments.

The immediate chairside control in direct bonding can also be a disadvantage, as errors may occur during the placement process. Repositioning of the brackets and archwire bend may be necessary, and the need for these adjustments can extend chair time and increase the likelihood of multiple appointments and lengthen overall treatment time.

Precise control over bracket angulation and position vertically and mesiodistally can be more challenging with direct bonding. Unlike indirect bonding, direct bonding does not allow for prepositioning of brackets and delivered in a custom tray. This can make it more difficult to visualize the final result and plan bracket positions in advance.

The direct bonding technique may also be less suitable for highly customized treatment plans, such as those involving specific torque or rotation requirements. Achieving these precise adjustments may be more challenging without the use of digital treatment planning and the use of custom trays that transfer the digital position of the bracket on the virtual models to the same position on the patient's actual tooth clinically.

The direct bonding technique may also be more susceptible to bonding failures, where brackets may detach from the teeth during treatment. Factors such as inadequate moisture control, contamination, insufficient adhesive curing time, or excessive movement of the bracket by the clinician to achieve an ideal bracket position that results in a partial cure of the adhesive can contribute to bonding issues.

In summary, both indirect and direct bonding techniques have advantages and disadvantages.

Regardless of the method used, the initial appliance placement (brackets), especially with direct bonding, typically includes some bracket-positioning errors. For example, the ability of the clinician, hygienist, or assistant to see posterior teeth in all planes of space is very difficult. The bracket needs to be placed in the ideal position vertically, mesiodistally, and horizontally; and be viewed from various planes of space to verify placement. Patient anatomy and physiology (cheeks, tongue, lips, and saliva) can also lead to positioning errors.

The varying level of knowledge, skill and experience between clinicians, hygienists, and assistants can also lead to significant positioning errors. Traditional and digital indirect bonding techniques consume a great deal of doctor time, laboratory time, resources in tray fabrication, and often leads to significant bond failures at the initial bonding appointment or in the future due to weaker bond strengths from tray movement and other procedural challenges with that technique.

These errors during treatment results in significant financial costs and treatment time delays. After many months of treatment, teeth that could have been in the optimal position had the bracket been initially placed properly are not. Archwire bends are needed to compensate for the misplaced brackets, or the brackets need to be removed and replaced with new, properly repositioned ones. These additional appointments consume additional time, money, and resources for both the patient and clinician.

### SUMMARY OF PARTICULAR EMBODIMENTS

It will be appreciated by those skilled in the art that other variations of the embodiments described below may also be practiced without departing from the scope of the invention. Further note, these embodiments, and other embodiments of the present invention will become more fully apparent from a review of the description and claims which follow.

It is an object of the present invention to provide a novel and inventive apparatus, system and method for facilitating the direct bonding of orthodontic brackets to a patient's teeth.

In one embodiment of the present invention, there is described an apparatus for use in direct bonding orthodontic applications, the apparatus comprising a body portion, the body portion comprising a first section, a second section and a medial section between the first and second sections, the first section shaped for engagement with a patient's front teeth, the first section including a plurality of guide sections, wherein each guide section generally comprises a first wall, a second wall and a medial wall for facilitating precise positioning and direct bonding (to the patient's teeth) of an orthodontic bracket within each guide section.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral.

For purposes of clarity, not every component may be labeled in every figure. In the drawings:

FIG. 1 is a perspective view of an exemplary direct bonding apparatus applied to a patient's upper teeth in accordance with one aspect of the present invention.

FIG. 2 is a perspective view of the apparatus of FIG. 1, wherein an orthodontic bracket has been applied to one of the patient's front teeth using the apparatus.

FIG. 3 is a front elevation view showing a close up section of the apparatus of FIG. 1 installed on a single tooth with an orthodontic bracket applied to the tooth.

FIG. 4 is a side cross-sectional view of a single tooth showing the apparatus of FIG. 1 installed on the tooth, and wherein an orthodontic bracket applied to the tooth.

FIG. 5 is an alternate side cross-sectional view of the tooth and apparatus of FIG. 4, wherein a portion of the apparatus is shown in a cut-away format so that the complete orthodontic bracket and bonding agent applied to the patient's tooth can be seen when viewed from a side of the tooth.

FIG. 6 is a perspective view of an alternative version of a direct bonding apparatus applied to a patient's upper teeth in accordance with one aspect of the present invention.

FIG. 7 is a perspective view of a further alternative version of a direct bonding apparatus applied to a patient's upper teeth in accordance with one aspect of the present invention.

FIG. 8 is a schematic diagram showing example guide section profiles.

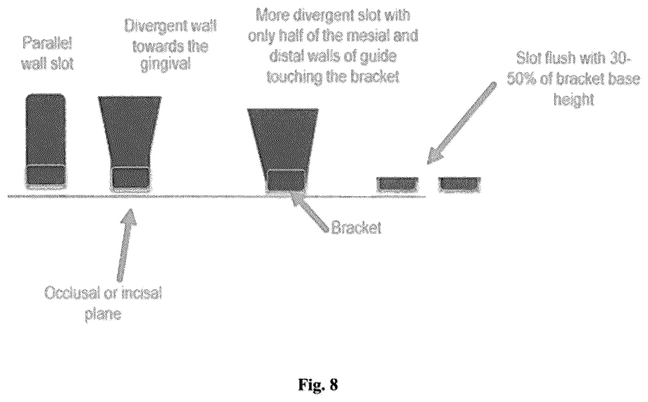

### DETAILED DESCRIPTION OF PARTICULAR EMBODIMENTS

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

References in the specification to “one embodiment”, “an embodiment”, “a preferred embodiment”, “an alternative embodiment”, “embodiments”, “variations”, “a variation” and similar phrases mean that a particular feature, structure, or characteristic described in connection with the embodiment(s) or variation(s) is included in at least an embodiment or variation of the invention. The appearances of the phrase “in one embodiment” or “in one variation” in various places in the specification are not necessarily all referring to the same embodiment or variation.

The term “couple”, “coupled”, “connected”, “joined”, “attached” or “fixed” as used in this specification and the appended claims refers to either an indirect or direct connection between the identified elements, components or objects. Often the manner of the coupling will be related specifically to the manner in which the two coupled elements interact.

The term “or” as used in this specification and appended claims is not meant to be exclusive rather the term is inclusive meaning “either or both”.

As used herein, “substantially” means sufficient to work for the intended purpose. As used herein, the terms “substantially” and “approximately” allow for minor, insignificant variations from an absolute or perfect state, dimension, measurement, result, or the like such as would be expected by a person of ordinary skill in the field, but that do not appreciably affect overall performance. When used with respect to numerical values, ratios, or parameters or characteristics that can be expressed as numerical values, the terms “substantially” and “approximately” mean within twenty percent (20%).

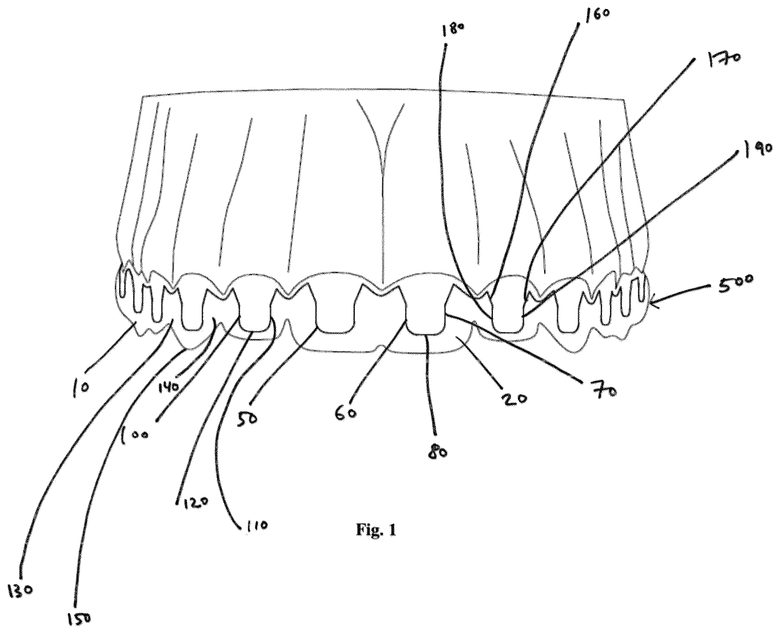

First referring to FIG. 1, there is shown a direct bonding guide (or apparatus) 500 in accordance with one aspect of the present invention installed on the user's upper teeth (on the upper jaw (maxilla)). It must be understood that the apparatus of the present invention can be formed for each of the user's upper and lower teeth (contained on the user's upper (maxilla) and lower jaws (mandible), respectively). In certain orthodontic applications, only a single apparatus will be employed (for example, where the patient desires to straighten his or her upper teeth only; in other applications, the patient may desire to straighten his or her lower teeth only; in other applications, the patient may desire to straighten only a portion of his or her teeth (e.g. the user's six front teeth on his or her upper jaw only). The apparatus of the present invention can be used in connection with a wide variety of orthodontic applications involving the user's teeth on either or both jaws, including applications in which only a portion of the teeth on a jaw are desired to be straightened.

The apparatus 500 of the present invention is intended to be used in direct bonding orthodontic applications as a means of facilitating the accurate, efficient and cost-effective positioning of orthodontic brackets on the user's teeth. The orthodontic brackets, themselves, do not form part of the present invention. Orthodontic brackets can take different forms and shapes, and can be bonded to a user's teeth using a variety of means. Bonding involves the use of a form of adhesive to secure the bracket to the user's teeth, where one bracket is applied to each of the teeth that are subjected to the orthodontic application. In many orthodontic applications, orthodontic brackets are bonded to all of the teeth (or the majority of the teeth) on the user's jaw (whether upper or lower jaw, or both).

Still referring to FIG. 1, there is shown an apparatus 500 for use in facilitating the direct bonding of orthodontic brackets to a user's teeth. The apparatus 500 is configured to fit around the user's teeth on the user's upper or lower jaw. Where orthodontic brackets are to be applied to teeth on each of the user's upper and lower jaws, then two separate apparatuses will be used, one for each jaw. The apparatus 500 comprises a first material having a first rigidity. The rigidity of the apparatus 500 need not be uniform throughout. The apparatus 500 may be composed of a number of suitable materials, including compositions of different materials. In a preferred configuration, the apparatus is composed of a plastic, thermoplastic or other suitable material or composition. The apparatus 500 must be composed of a sufficiently rigid material to maintain structural integrity of the apparatus 500 upon application to the user's teeth, and to prevent undue bending or movement of the apparatus 500 or its components, including in response to placement and bonding of orthodontic brackets on the user's teeth when the apparatus 500 has been installed on the user's teeth. At the same time, the apparatus 500 must be sufficiently flexible to permit easy installation on the user's teeth, including an manipulation of the apparatus 500 to ensure a secure fit.

The apparatus 500 is not intended to apply any orthodontic force to the user's teeth. Rather, the apparatus 500 is intended to guide the positioning and securement of orthodontic brackets to the user's teeth.

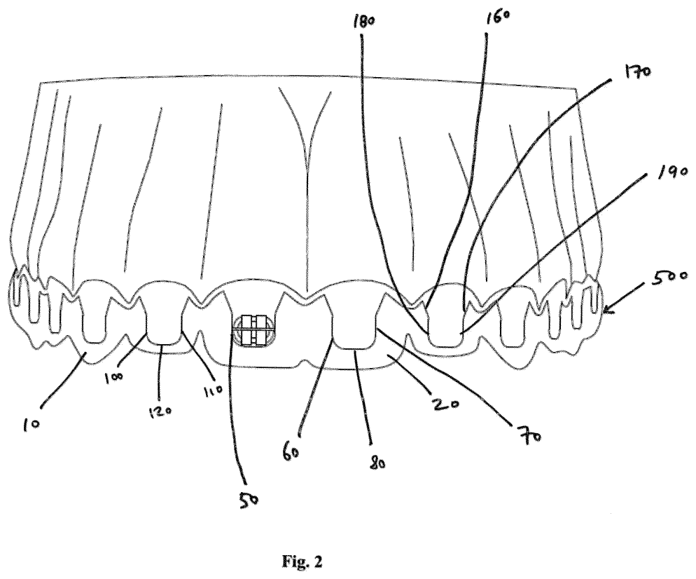

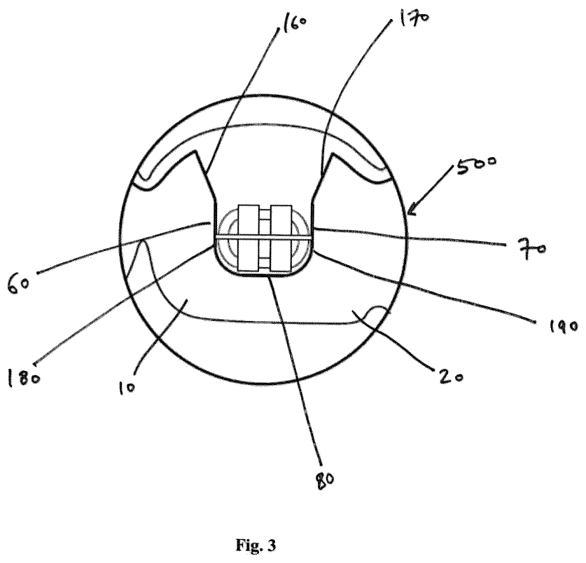

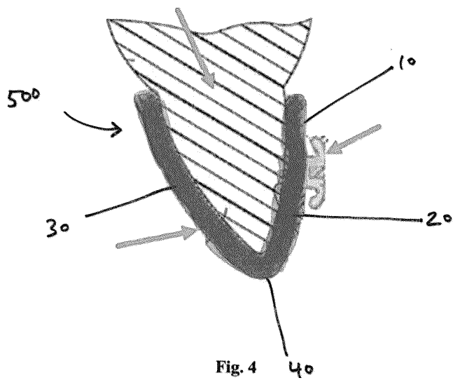

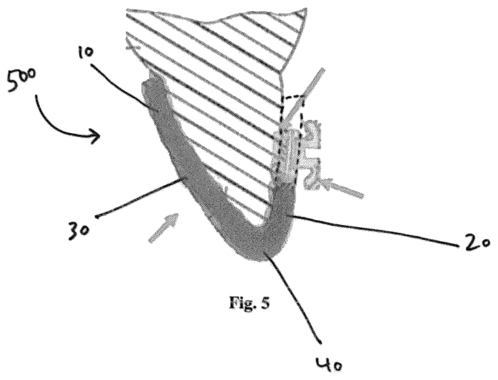

Referring to each of FIGS. 1-5, the apparatus 500 includes a body portion 10 comprising a first section 20 and a second section 30, wherein the first section 20 and the second section 30 are connected by a medial section 40. The first section 20 is shaped for engagement with the front of the user's teeth on the same jaw, wherein the first section 20 is configured to include a plurality of guide sections 50, wherein each guide section 50 generally comprises a first wall 60, a second wall 70 and a medial wall 80, wherein the first, second and medial walls 60, 70 and 80, are formed as a continuous wall, and wherein the medial wall 80 connects the first wall 60 to the second wall 70 within each guide section 50.

In one embodiment, the perimeter of each guide section 50 is sized to be slightly larger than the outward dimensions of the orthodontic bracket to be applied to each tooth. If each guide section 50 was of a size less than or equal to the outward dimensions of the bracket to be applied, then the apparatus 500 would interfere with the bonding of brackets to the user's teeth. A single guide section 50 is disposed on the outer surface of each portion of the first section 20 which covers each tooth for which an orthodontic bracket is to be applied, meaning that there is one guide section disposed on each tooth (to which a bracket will be bonded).

The walls 60, 70, and 80 which comprise each guide section 50 may be tapered so that the distal side 100, 110 and 120 of these walls are thinner than the proximal side 130, 140 and 150 thereof. Tapering the distal ends walls 60, 70 and 80 of the walls 60, 70 and 80 of each guide section 50 reduces the likelihood that the apparatus 500 installed on a user's teeth will interfere with the positioning and adhesion of orthodontic brackets on the user's teeth.

The second section 30 of the apparatus 500 is shaped for engagement with the back surface (or a portion of the back surface) of the user's teeth on the same jaw. Further, unlike the first section 20, which is configured to include a plurality of guide sections 50, the second section 30 does not include any guide sections are apertures. Rather, the second section 30 is configured as a continuous wall which wraps around the backs of the user's teeth on the same jaw, or substantial portions of the backs of the user's teeth on the same jaw.

Preferably, the second section 30 should be configured so that the second section 30 does not contact the user's gums on the backs of the user's teeth. In this regard, in a preferred embodiment, the second section 30 is configured to leave a small gap between the uppermost portion of the second section 30 on each tooth and the user's gums in contact with each tooth.

In addition, preferably, the first section 20 should be configured so that the first section 20 does not contact the user's gums on the fronts of the user's teeth. In this regard, in a preferred embodiment, the first section 20 is configured to leave a small gap between the uppermost portion of the first section 20 on each tooth and the user's gums in contact with each tooth.

It should be noted that the apparatus need not have a uniform thickness. This means that the components of the apparatus 500 can be of varying thicknesses to support the most effective and efficient configuration of the apparatus for its intended purpose in facilitating direct bonding of orthodontic brackets to a user's teeth. In this regard, the apparatus 500 and/or components thereof should be of a thickness (or thicknesses) sufficient to confer sufficient structural rigidity on the apparatus 500. In one embodiment, both the first, second and medial sections (20, 30 and 40) of the body portion 10 are of the same general thickness. In another embodiment, the second section 30 is thicker than the first section 20 or the medial section 40. Other combinations of component relative thicknesses are contemplated.

In order to support a prototypical facial and buccal surface direct bonding procedure, the first 20, second 30 and medial 40 sections of the apparatus 500 are intended to cover portions of the lingual, occlusal surface, and facial/buccal surfaces of the user's teeth. In one example embodiment, each guide section 50 is configured to permit accurate placement (whether by direct positioning of a bracket on the front of the user's tooth, or by permitting the sliding of the bracket from a position above (or in the proximity of) the user's gum-line into position within the guide section 50, such that the bracket rests against or adjacent to the walls 60, 70 and 80 or portions of the walls 60, 70 and 80 (or against or adjacent to any of the walls 60, 70 or 80 or any combination of multiple walls 60, 70 and/or 80).

In one embodiment of the apparatus 500 of the present invention, the walls 60 and 70 of each guide section 50 are configured such that the vertical height of the walls 60 and 70 are identical. In another embodiment of the apparatus 500 of the present invention, the walls 60 and 70 of each guide section 50 are parallel or substantially parallel. In yet another embodiment of the apparatus 500 of the present invention, each of the walls 60 and 70 (of each guide section 50) comprise a first segment 160, 170 and a second segment 180, 190. In another embodiment of the apparatus 500 of the present invention, each first segment 160, 170 of each of the walls 60 and 70 is angled away from each second segment 180, 190 of the walls 60 and 70 in order to facilitate ready sliding and positioning of each bracket within each guide section 50. In another embodiment of the apparatus 500 of the present invention, each second segment 180, 190 (of each of the walls 60, 70) and each medial section 80 is sized and shaped to receive an orthodontic bracket. In another embodiment of the apparatus 500 of the present invention, the length of each first segment 160, 170 is equal or substantially equal to the length of each second segment 180, 190. In another embodiment of the apparatus 500 of the present invention, the height of each first segment 160, 170 is equal or substantially equal to the height of each second segment 180, 190. In one embodiment, the height of each second segment 180, 190 is approximately the same height as the height of the bracket to be positioned within each guide section 50.

In one embodiment of the apparatus 500 of the present invention, each guide section 50 extends from the gingival region of the guide section with parallel (or substantially parallel) walls 60, 70 which are spaced apart by a width equal (or substantially equal) to the width of the bracket to be bonded. In one embodiment, the guide section 50 walls 60, 70 diverge gingivally to permit easier bracket placement, and taper toward the uppermost edges of the guide section 50 walls 60, 70 in the vicinity of the uppermost section of each bracket.

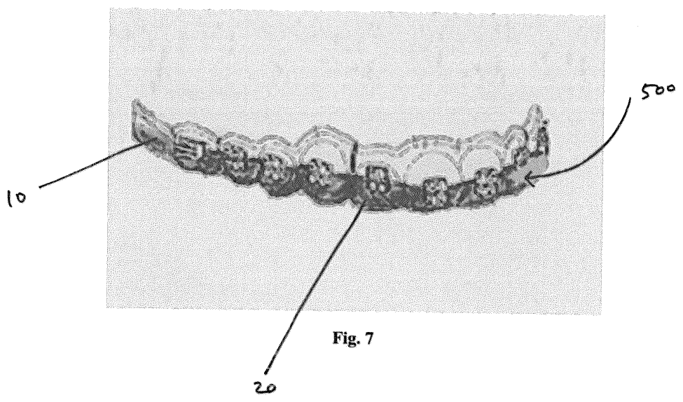

In one embodiment of the apparatus 500 of the present invention, each guide section 50 is disposed directly adjacent to (or into contact with each bracket at the following locations: the incisial or occlusal edge, the medial edge and the distal edge. FIG. 7 shows example embodiments of the varying degrees of tapering (or shaping) of each guide section 50 to facilitate easier placement of each bracket within each guide section 50.

In one embodiment of the apparatus 500 of the present invention, the perimeter of each guide section 500 could be colored to permit better visualization intraorally. Alternatively, the entire apparatus, rather than being transparent, could have a color or shade selected by the clinician during the digital setup with a level of transparency that allows for improved visualization of the white of the enamel of each tooth intraorally. For example, in one embodiment, the apparatus 500 can be composed to be semi-transparent in order to enable the clinician to readily identify that the apparatus 500 is fully seated on the user's teeth.

In one embodiment of the apparatus 500 of the present invention, each guide section 50 is shaped and sized to form a slot 200 for receiving an orthodontic bracket. This configuration enables the clinician to readily place each bracket into each slot 200 without error vertically, mesiodistally, or rotationally and bond each bracket directly to each tooth. Further, since each guide section 50 extends towards the gingival part of each tooth and is open at that end, the clinician can easily position the apparatus 500 on the user's teeth, and easily remove the apparatus 500 after direct bonding of the orthodontic brackets has occurred.

In one embodiment, the apparatus 500 is scalloped around all of the teeth sections on the facial, buccal, lingual and palatal surfaces. In one embodiment, the apparatus 500 does not extend above the cervical margin of each tooth.

The apparatus 500 could be adapted to include an at least one anchor member (not shown) for facilitating securement of the apparatus 500 to a user's teeth. Where the apparatus 500 includes sections for placement around the user's molars, these sections will aid in the securement of the apparatus 500 to the user's teeth without the need for an anchor member. Further, since the apparatus 500 is sized to fit snugly against the user's teeth, the tight, friction fit of the apparatus 500 against the user's teeth will hold the apparatus 500 in place without the need for an anchor member.

In an example computer-based process implementation of the apparatus 500 and system of the present invention, a digital scan of the patient's teeth is conducted in order to ensure proper bracket alignment. The digital scan would typically include a scan of all the teeth and the occlusal bite is also obtained (typically, by the clinician or auxiliary staff).

Next, the clinician selects from a digital inventory (or database) of brackets, those same brackets that are used in their clinic. For example, brackets made from various suppliers (3M™, American Ortho™, Ormco™, Speed™, etc.) with multiple prescriptions can be selected from the digital inventory. These digital brackets are accurate representations of the physical brackets from the manufacturer and typically kept in inventory at the dentist's office.

Once the digital bracket selected, the software program places the digital bracket in the ideal position of each individual tooth in all three planes of space as the original setup. The doctor can review and modify the position of any bracket on any tooth based of the predicted treatment outcome displayed by the software.

The software program digitally simulates treatment from initial archwire to final position of the teeth based on the initial placement of the bracket and the bracket prescription based on the dentist's chosen treatment parameters. If the final tooth position is not ideal, the clinician can then reposition the bracket, change the prescription of the bracket, or change the bracket type. For example, the clinician may choose to overcorrect for a rotated tooth and place a bracket more mesial or distal to help minimize relapse after treatment. Once the final tooth position is as desired, the bracket type and bracket positions are accepted and approved.

Next, a clear plastic direct bonding guide (or apparatus) 500 is fabricated from the 3D digital model, and the finalized digital bracket placement and shipped to the clinician's office. The apparatus 500 includes a custom fitted slot for each bracket to be bonded to the patient's teeth. This allows the clinician to place each bracket into a custom slot without error vertically, mesiodistally, or rotationally and to bond the bracket directly to the tooth with precision.

Once the brackets are bonded to the teeth, the apparatus 500 is removed by applying force from the facial/buccal to the lingual side of the user's mouth. The apparatus 500 can be designed to include segmentations, or perforations to permit easy removal of the apparatus 500 from the user's teeth, by folding or bending the apparatus 500 along the predetermined lines of segmentation (or perforation).

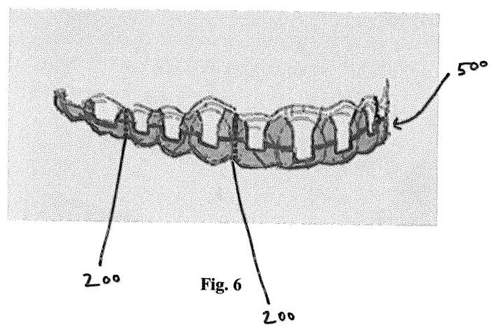

An example embodiment of the apparatus 500 is shown in FIG. 6 which includes a plurality of segmentations (or perforations) 800. In the embodiment shown in FIG. 6, the segmentations (or perforations) 800 are positioned along the line separating two adjacent teeth of the user and the segmentations (or perforations) 800 are disposed intermittently (e.g. once every three or four teeth) along a front side of the apparatus 500. By positioning the segmentations (or perforations) 800 in this way, the clinician will be able to more readily remove the apparatus 500 upon successful bonding of the brackets to the user's teeth, by bending the apparatus 500 in the vicinity of each bracket at the points of segmentation 800 positioned along the apparatus 500.

FIG. 7 illustrates a further alternative version of the apparatus 500 applied to a patient's upper teeth, wherein each guide section 50 still generally comprises a first wall 60, a second wall 70 and a medial wall 80 (as in the version of the apparatus 500 depicted in FIG. 1), however, the first and second wall 60, 70 of each guide section 50 are shorter than the first and second walls 60, 70 shown in FIG. 1, such that each guide section 50 is configured as a shallower guide (than the version of the apparatus 500 depicted in FIG. 1) for positioning brackets on the user's teeth. In the embodiment shown in FIG. 7, the first section 20 of the apparatus 500 is of a height roughly equal to half the height of each tooth. Alternatively, the height of the first section 20 is in the range of approximately half the height of each tooth to approximately three-quarters the height of each tooth. In the further alternative, the height of the first section is between 25% and 50% of the height of The heights of the first and second walls 60, 70 of each guide section 50 must be sufficiently tall to permit proper function of the apparatus 500 (i.e. to permit ready and accurate positioning of brackets within each guide section 50. In the embodiment shown in FIG. 7, the height of each first and second wall 60, 70 is approximately half the height of each bracket. Alternatively, the height of each first and second wall 60, 70 could fall in the range of approximately half the height of each bracket to approximately three quarters of the height of each bracket. In the embodiment shown in FIG. 7, the first and second walls 60, 70 of each guide section 50 are parallel or substantially parallel to one another. In the further alternative, the height of the first and second walls 60, 70 of each guide section 50 falls in the range of approximately 25% and 50% of the height of each bracket.

Use of the direct bonding guide eliminates bracket placement errors, eliminates the need for visualization checks in the mouth, provides consistent and accurate bracket placement regardless of skill level, and eliminates the need for compensatory wire bends or bracket repositioning appointments. This, in turn, increases consistency, reduces training hours, reduces treatment time, reduces the number of needed appointments, reduces costs, and produces better treatment outcomes for patients.

Furthermore, use of the direct bonding guide makes etching of the teeth and application of the bonding agent more accurate, and unwanted flash is also reduced. The time required to bond a complete case is minimized, the movement of the bracket during traditional placement and before curing to “check” the bracket position (which leads to suboptimal bond strength and costly bond failures in the future) is also eliminated. A single tray versus the double tray techniques for indirect bonding would reduce material costs, production costs, shipping costs, and processing costs.

The apparatus, system and process of the present invention also permits the clinician to use existing bracket inventory at the initial appointment and consume less bracket inventory (caused by the traditional method of direct bonding and the need for repositioning (new bracket in a new position)). It would also be possible to ship the individual physical brackets (from the selection phase) with the direct bonding guide, but this step is technically not needed as the bracket fabrication tolerances and digital files of the bracket bases should be accurate to allow for an ideal placement with the use of the guide.

The apparatus, system and process of the present invention also eliminates the need for use of various intraoral measurement instruments that clinicians use to help determine the ideal bracket placement. All kinds of errors are introduced when using these instruments.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any modification, combination or permutation of any of the components, elements, functions, operations, or steps described or illustrated anywhere herein that a person having ordinary skill in the art would comprehend. All such modifications, combinations and permutations are believed to be within the sphere and scope of the invention as defined by the claims appended hereto.

We claim:

1. An apparatus for use in direct bonding orthodontic applications, the apparatus comprising:
a body portion, the body portion comprising a first section, a second section and a medial section between the first and second sections,
the first section shaped for engagement with a patient's front teeth,
the first section including a plurality of guide sections,
wherein each guide section generally comprises a first wall, a second wall and a medial wall for facilitating precise positioning and direct bonding (to the patient's teeth) of an orthodontic bracket within each guide section.

2. The apparatus of claim 1, wherein the first, second and medial wall of each guide section forms a continuous wall.

3. The apparatus of claim 1, wherein the first, second and medial wall of each guide section is tapered along a distal side thereof.

4. The apparatus of claim 1, wherein the second section is shaped for engagement with the back surface of the patient's teeth.

5. The apparatus of claim 1, wherein the first section is configured such that no part of the apparatus touches the user's front gum-line.

6. The apparatus of claim 1, wherein the second section is configured such that no part of the apparatus touches the user's back gum-line.

7. The apparatus of claim 1, wherein the apparatus is of a uniform thickness throughout.

8. The apparatus of claim 1, wherein the apparatus is comprised of a thermoplastic material.

9. The apparatus of claim 1, wherein the apparatus is shaped to fit over a plurality of the patient's teeth on the same jaw.

10. The apparatus claim 1, wherein of first, second and medial sections of the apparatus are shaped to cover portions of the lingual, occlusal surface, and facial/buccal surfaces of the patient's teeth.

11. The apparatus of claim 1, wherein each first and second wall of each guide section comprise a first segment and a second segment wherein each first segment is angled away from each second segment.

12. The apparatus of claim 11, wherein the second sections together with the medial wall of each guide section are sized and shaped to receive an orthodontic bracket.

13. The apparatus of claim 1, wherein the apparatus is scalloped around all of the teeth sections on the facial, buccal, lingual and palatal surfaces of the patient's teeth.

14. The apparatus of claim 1, wherein the apparatus does not extend above the cervical margin of each of the patient's teeth.

15. The apparatus of claim 1, wherein the apparatus is sized to be capable of being releasably securable to the patient's teeth in a friction fit arrangement.

16. The apparatus of claim 1, further comprising a plurality of segmentations disposed along a frontal plane of the first section.

17. The apparatus of claim 16, wherein each of the plurality of segmentations is disposed intermittently along a vertical axis of the first section.
